(19) United States
(12) Patent Application Publication
(10) Pub. No.: US 2009/0080874 A1
(43) Pub. Date: Mar. 26, 2009

(54) PHOTOGRAPHIC APPARATUS, METHOD OF CONTROLLING THE SAME, PROGRAM FOR CONTROLLING THE SAME, AND RECORDING MEDIUM STORING THE PROGRAM

(75) Inventors: Tatsuhiko Ikehata, Ome-shi (JP); Tatsuro Abe, Ome-shi (JP); Kei Tashiro, Ome-shi (JP); Shiro Nagaoka, Ome-shi (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/204,205

(22) Filed: Sep. 4, 2008

(30) Foreign Application Priority Data
Sep. 21, 2007 (JP) 2007-245206

(51) Int. Cl. G03B 17/00

(52) U.S. Cl. 396/50

(57) ABSTRACT

According to one embodiment, there is provided photographic apparatus which has image acquisition unit, image processing unit configured to process the image data acquired by image acquisition unit, display unit configured to display the image represented by the imaged data processed by image processing unit, attitude detection unit configured to detect the attitude of photographic apparatus and outputs attitude information, and control unit configured to controls image acquisition unit, image processing unit and display unit. The control unit outputs, to display unit, an inclination reference image that enables a user to visually perceive how much an image photographed when photographic apparatus actually inclines is inclined to an image photographed when photographic apparatus does not incline at all. The control unit controls the density of the inclination reference image, increasing the density when the inclination of photographic apparatus is large, and decreasing the density when the inclination is small.

### CROSS-REFERENCE TO RELATED APPLICATIONS

This application is based upon and claims the benefit of priority from Japanese Patent Application No. 2007-245206, filed Sep. 21, 2007, the entire contents of which are incorporated herein by reference.

### BACKGROUND

1. Field

One embodiment of the invention relates to a photographic apparatus, a method of controlling the apparatus, a program for controlling the apparatus, and a recording medium storing the program.

2. Description of the Related Art

Each photographic apparatus, such as a video camera or an electronic camera, incorporates an attitude detection unit that detects the attitude (inclination) of the photographic apparatus.

For example, Japanese Patent Application Publication (KOKAI) No. 2006-165941 describes a photographic apparatus that displays an image in accordance with the data detected by the attitude detection unit incorporated in it. This photographic apparatus displays an image from which the user can visually perceive its attitude.

More precisely, the display unit of the photographic apparatus displays grid lines fixed in position, some extending vertically and the others extending horizontally. Further, the display unit displays a horizon indication line, superimposed on the grid lines. If the user sees the grid lines inclining to the horizon indication line, the user can recognize that the photographic apparatus is inclined. Then, the user may rotate the apparatus until the grid line cease to incline to the horizon indication line. The attitude of the photographic apparatus can thereby be corrected.

However, the display unit of the photographic apparatus described in Publication No. 2006-165941 displays the grid lines in a dark color all the time the apparatus remains switched on. The grid lines so displayed may annoy the user. For example, if some grid lines overlap the image of the object that the user wants to photograph, they disable the user to view the object clearly or accurately.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1A is an exemplary diagram showing an outer appearance of a photographic apparatus according an embodiment of the present invention;

FIG. 1B is an exemplary diagram showing an outer appearance of a photographic apparatus according an embodiment of the present invention;

FIG. 2 is an exemplary diagram showing the electric function blocks incorporated in the photographic apparatus of FIG. 1;

FIG. 3 is an exemplary diagram showing the function blocks incorporated in the control unit shown in FIG. 2;

FIG. 4A is an exemplary diagram showing an inclination reference image that is one of the characterizing features of the present invention;

FIG. 4B is an exemplary diagram showing an inclination reference image that is one of the characterizing features of the present invention;

FIG. 4C is an exemplary diagram showing an inclination reference image that is one of the characterizing features of the present invention;

FIG. 5A is an exemplary diagram showing another type of an inclination reference image, which is one of the characterizing features of the present invention;

FIG. 5B is an exemplary diagram showing another type of an inclination reference image, which is one of the characterizing features of the present invention;

FIG. 5C is an exemplary diagram showing another type of an inclination reference image, which is one of the characterizing features of the present invention;

FIG. 6 is an exemplary diagram explaining how to extract a part of the original image to generate a corrected horizontal image by extract;

FIG. 7 is a flowchart explaining how the system control unit performs a process to display an inclination reference image in a method;

FIG. 8 is a flowchart explaining how the system control unit performs a process to display an inclination reference image in a different method; and

FIG. 9 is a flowchart explaining how the system control unit performs a process to display an inclination reference image in another different method.

### DETAILED DESCRIPTION

Various embodiments according to the invention will be described hereinafter, with reference to the accompanying drawings.

In general, according to one embodiment of the invention, a photographic apparatus according to one embodiment of the invention comprises: an image acquisition unit configured to acquire image data; an image data processing unit configured to process the image data acquired by the image acquisition unit; a display unit configured to display an image represented by the image data processed in the image data processing unit; an attitude detection unit configured to detect the main body of the photographic apparatus and output attitude information; and a control unit configured to control the image acquisition unit, the image data processing unit and the display unit. The control unit has a reference image output unit and a density control unit. The reference image output unit is configured to output, to the display unit, an inclination reference image that enables a user to visually perceive how much an image photographed when the main body actually inclines is inclined to an image photographed when the main body does not incline at all. The density control unit is configured to control the density of the inclination reference image, increasing the density when the inclination of the main body is large, and decreasing the density when the inclination of the main body is small.

Embodiments of this invention will be described in detail with reference to the accompanying drawings.

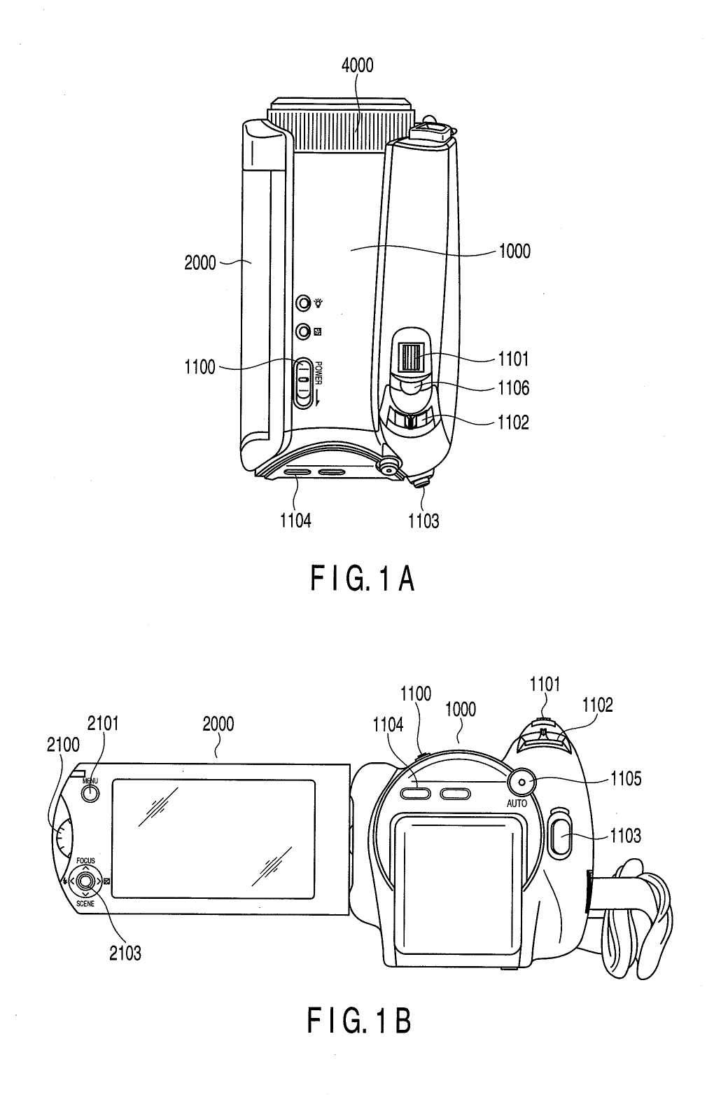

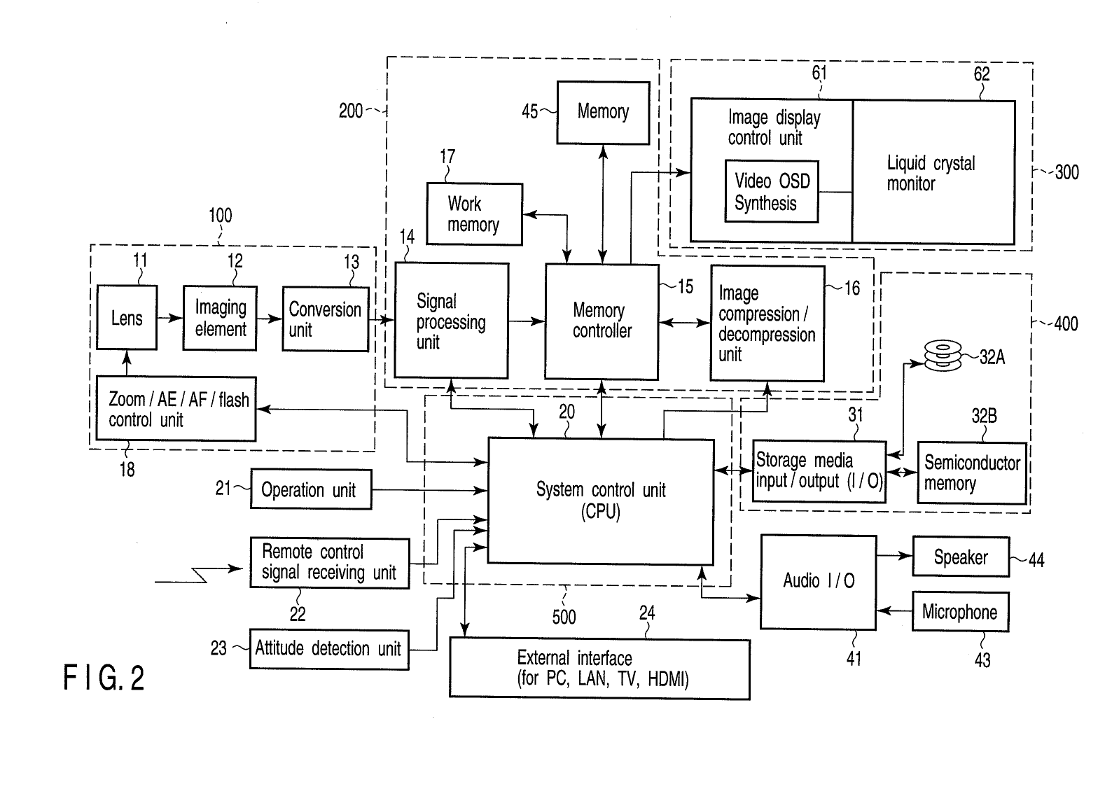

FIG. 1A and FIG. 2B are exemplary diagrams showing a photographic apparatus according an embodiment of the present invention, for example a high-definition video camera.

FIG. 1A is a top view of the high-definition video camera that is a photographic apparatus according to the embodiment. FIG. 1B is a rear view of the high-definition video camera. As FIG. 1A and FIG. 2B show, the high-definition video camera comprises a photographic unit 1000, a display panel 2000, and a lens unit 4000.

The photographic unit 1000 has a power switch 1100, a zoom lever 1101, a photography/playback switching button 1102, a photography button 1103, a chapter button 1104, an automatic setting button 1105, and a still-image photography button 1106.

The power switch 1100 may be operated to switch the power supply state of the high-definition video camera. The power switch 1100 may be operated to adjust the focal distance of the lens of the lens unit 4000.

The photography/playback switching button 1102 may be pushed to switch the operation mode of the high-definition video camera, from the photography

mode to the playback mode, or vice versa. In the photography mode, the high-definition camera takes a moving picture. In the playback mode, it playbacks plays back the moving picture.

When pushed while the high-definition video camera remains in the photography mode, the photography button 1103 causes the camera to take and record pictures. The chapter button 1104 may be pushed to set a chapter to the video data recorded.

When pushed, the automatic setting button 1105 automatically sets various photographic conditions of taking pictures, such as sensitivity and brightness. When pushed, the still-image photography button 1106 causes the high-definition video camera to photograph still images.

The display panel 2000 is a display unit of the high-definition video camera. It is secured to the photographic unit 1000, and can be opened and closed with respect to the photographic unit 1000. The display panel 2000 is usually held in a receptacle made in the photographic unit 1000. It is opened as shown in FIG. 1B, so that it may be used. Further, the display panel 2000 can be rotate around its longitudinal axis.

The display panel 2000 has a liquid-crystal monitor. The liquid-crystal monitor displays the image that the high-definition video camera is photographing. The display panel 2000 is constituted by a high-definition video camera screen that has an aspect ratio of 16:9

On the frame of the display panel 2000, there are arranged a jog dial 2100, a menu button 2101, a multifunction button 2103.

The jog dial 2100 is, for example, a rotatable dial, and may be rotated to select the various functions of the high-definition video camera. When pushed, the menu button 2101 causes the display panel 2000 to display an operation menu of the camera.

The multifunction button 2103 comprises a ring and an OK button. The ring performs the function of a cross key. The ring can select one of various functions as it is pushed at the upper part, lower part, left part or right part. The OK button is located at the center, or in the ring. When depressed, the OK button sets the function selected by operating the function of an enter key.

The menu button 2101, jog dial 2100 and multifunction button 2103 are located adjacent to one another. This makes it easy for the user to push the OK button after operating the jog dial 2100.

More precisely, the user can operate the menu button 2101, the jog dial 2100 and multifunction button 2103 with left thumb of the user while holding the photographic unit 1000 in right hand of the user the frame of the display panel 2000 in left hand of the user. Thus, the photographic apparatus according to the embodiment excels in operability.

The lens unit 4000 is provided to photographic images. It has a photograph lens for receiving the light from an object.

FIG. 2 is an exemplary diagram showing the optical system and the electric system, both incorporated in the high-definition video camera described above. As shown in FIG. 2, the high-definition video camera comprises an image acquisition unit 100, an image processing unit 200, a display unit 300, a storage unit 400, and a control unit 500.

The image acquisition unit 100 comprises a lens 11, an imaging element 12, an analog-to-digital conversion unit 13, and a control unit 18. An object image received at the lens 11 is focused on the focusing surface of the imaging element 12 (e.g., CCD imaging element).

The imaging element 12 converts the object image to an electric signal, which is supplied to the analog-to-digital conversion unit 13. The analog-to-digital conversion unit 13 converts the electric signal to a digital signal (acquired image data). The digital signal is input to a signal processing unit 14 that is connected to the output of the analog-to-digital conversion unit 13.

The control unit 18 can perform automatic iris adjustment (AE), automatic focus adjustment (AF), flash control, etc., in accordance with control signals supplied from the control unit 500.

The image processing unit 200 comprises a signal processing unit 14, a memory controller 15, an image compression/decompression unit 16, a work memory 17, and a memory 45. The signal processing unit 14 performs gamma correction, color signal separation, white balance adjustment, etc. on an image receives from the image acquisition unit 100.

Unless the photography initiating operation (shutter release) is performed in the ordinary photography mode, the image data is input from the signal processing unit 14 to an image display control unit 61 via the memory controller 15.

When the photography start operation (shutter release) is performed, the image compression/decompression unit 16 compresses the image data in order to store the image data into the storage unit 400 (by means of, for example, JPEG data compression). That is, the image data is converted to image data that can be displayed.

The work memory 17 is used to edit the image data, to generate thumbnail images, or to change the order of images. More precisely, the work memory 17 temporarily stores the image data to be processed. The work memory 17 functions as a temporary storage unit.

Further, the work memory 17 is used to edit various icons. The work memory 17 can store one frame of image data or some frames of image data. The image data stored in the work memory 17 is input to the image display control unit 61 via the memory controller 15.

The display unit 300 has an image display control unit 61 and a liquid-crystal monitor 62. The image display control unit 61 performs an image conversion process and video ODS synthesis. In the image conversion process, the image display control unit 61 converts the received image data to data that the liquid-crystal monitor 62 can display. In the video ODS synthesis, the image display control unit 61 generates display parts (e.g., icons) that the liquid-crystal monitor 62 can display.

The liquid-crystal monitor 62 sequentially displays the image data items it has received. Thus, the liquid-crystal monitor 62 displays the image being photographed or an object image to be photographed.

The storage unit 400 has a storage media input/output (I/O) 31. A storage medium (recording medium), such as a hard disk (HD) 32A or a semiconductor memory 32B, is provided in the storage media I/O 31.

Under control of the control unit 500, image data to record is stored into the storage medium provided in the storage media I/O 31. The image data is supplied to the image compression/decompression unit 16 if it is read from the storage medium provided in the storage media I/O 31, under control of the control unit 500. The unit 16 expands the image data and thereby converted to image data to display. The image data to display is input via the memory controller 15 to the image display control unit 61.

Thus, the liquid-crystal monitor 62 displays the image reproduced. The recording medium is not limited to those specified above. It may be, for example, an optical disk (DVD).

The control unit 500 has a system control unit 20. The system control unit 20 controls the other components of the high-definition video camera. The system control unit 20 is composed of a CPU, a buffer memory, and a program memory. The buffer memory is, for example, a RAM that serves as a working storage area for the CPU. The program memory is, for example, a ROM that stores various programs and various control programs that the CPU may execute.

The system control unit 20 executes the programs stored in the program memory to perform various functions.

The high-definition video camera further comprises an operation unit 21, a remote control signal receiving unit 22, an attitude detection unit 23, an external interface 24, an audio I/O 41, a microphone 43, and a speaker 44.

The operation unit 21 has the buttons and switches that are shown in FIG. 1A and FIG. 1B. When operated, the operation unit 21 inputs various operation signals. The remote control signal receiving unit 22 is designed to receive the operation signals input at the operation unit 21. The control unit 500 controls the other components of the high-definition video camera, in accordance with the operation signals input at the operation unit 21 and the signals received at the remote control signal receiving unit 22.

The attitude detection unit 23 is designed to detect how much the high-definition video camera inclines to the horizon. The unit 23 is an angle detection device such as an inclination sensor, a horizon sensor, or a gyro sensor. The unit 23 detects that the inclination (attitude) of the camera, either to the left or to the right around the axis of the light beam that the lens 11 receives during the photography. The unit 23 generates a digital signal representing the inclination. This digital signal is transmitted to the control unit 500. To be more specific, the attitude detection unit 23 detects how the lens 11 inclines to the axis of the light beam it receives and determines the attitude of the lens 11. The attitude detection unit 23 generates a digital signal representing the inclination detected. The digital signal is transmitted to the control unit 500.

The external interface 24 is an interface that can be connected to an external apparatus such as a personal computer and a television receiver. The external interface 24 is, for example, LAN, USB, High-Definition Multimedia Interface (HDMI), or the like.

The microphone 43 acquires audio data while the high-definition video camera is photographing an object or editing the image data it has generated. The audio data the microphone 43 has acquired is input via the audio I/O 41 to the control unit 500. The control unit 500 can record the audio data in the storage medium, in association with the image data.

To play back the audio data thus recorded, the control unit 500 reads the audio data from the storage medium, together with the image data. While the image data is being played back, the speaker 44 generates the sound represented by the audio data read from the storage medium. Nonetheless, in this invention, the speaker 44 may be set to silent mode if the user wants to have the image data played back in order to examine the image photographed.

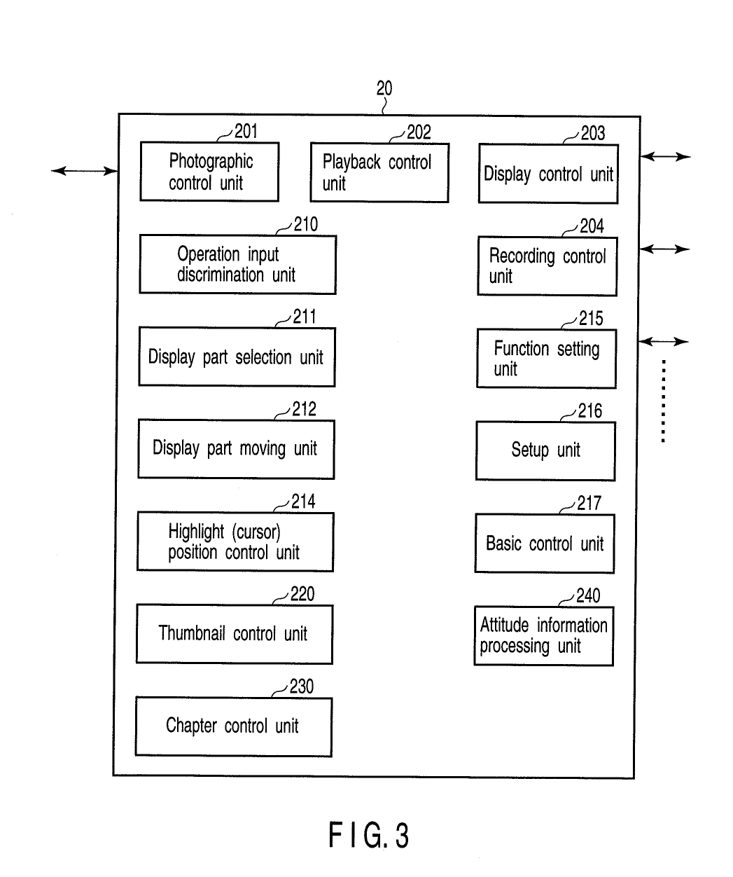

FIG. 3 is an exemplary diagram showing some of the function blocks provided in the system control unit 20.

The photographic control unit 201 sets the photography mode and controls some components of the high-definition video camera in accordance with operation signals input. The playback control unit 202 sets the playback mode in response to an operation signal input. The display control unit 203 causes the liquid-crystal monitor 62 to display the image represented by the image data supplied from the image processing unit 200.

The recording control unit 204 controls some components of the high-definition video camera so that the image data acquired may be compressed in the image processing unit 200 and then recorded in the recording medium selected. The operation input discrimination unit 210 analyzes the operation signals input at the remote control signal receiving unit 22 and discriminates each operation signal from any others.

The display part selection unit 211 selects any display parts (ions, marks, etc.) to display in a menu screen. Various display parts are stored in a memory or in the image display control unit 61.

The display part moving unit 212 can move and erase the display parts in the display screen of the liquid-crystal monitor 62, in response to an operation signal input. The highlight (cursor) position control unit 214 controls the highlight position (cursor position) in response to an operation signal input.

The function setting unit 215 is a component that cooperates with the setup unit 216 to set various functions to the photographic apparatus. The basic control unit 217 is a component that controls the basic operations such as data transfer, data reading and timing setting. The thumbnail control unit 220 controls the forming of thumbnails, the displaying of thumbnails, the scrolling of thumbnails, and the like.

The chapter control unit 230 has the function of managing the chapters of a moving picture. That is, the chapter control unit 230 generates chapters, sets images representing the chapters generated and forms small images representing the chapters.

The attitude information processing unit 240 calculates the inclination of the high-definition video camera, i.e., the angle at which the camera inclines to the horizon, from the attitude signal supplied from the attitude detection unit 23. When the attitude information processing unit 240 detects the inclination of the high-definition video camera, the display control unit 203 causes the display part selection unit 211 to select the display part (inclination reference image) that informs the user of the inclination of the high-definition video camera.

The display control unit 203 causes the liquid-crystal monitor 62 to display the inclination reference image in combination with the image represented by the image data. In this case, the display control unit 203 changes the display density (transmittance) of the inclination reference image in accordance with the inclination of the high-definition video camera, which has been detected by the attitude information processing unit 240.

More precisely, the display control unit 203 outputs an inclination reference image that enables the user to recognize visually how much the image of the camera is inclined to an image of the camera, which is not inclined at all. The display control unit 203 functions as a reference image output unit.

The display control unit 203 controls the density of the inclination reference image in accordance with the inclination detected by the attitude information processing unit 240, i.e., the inclination of the high-definition video camera. Thus, the display control unit 203 functions as a density control unit, too.

If the inclination of the high-definition video camera is smaller than a prescribed threshold value, the recording control unit 204 performs image correction by extracting pixels. In other words, the unit 204 performs, for example, affine transformation, thereby extracting some pixels and cancelling out the inclination of the original image. As a result, a corrected image not inclined to the horizon at all is obtained.

The recording control unit 204 records the corrected horizontal image generated by extracting pixels, in the recording medium. That is, the recording control unit 204 controls that region of the work memory 17 of the image processing unit 200, from which the image data temporarily stored should be read. The recording control unit 204 can thus correct the inclination of the image to record.

To generate a corrected horizontal image, a part of the original image is extracted. Therefore, the original image should better be larger than the corrected horizontal image to generate. Since the image transformation achieved by rotating the original image may result in image distortion, the image data is filtered before or after the transformation, thereby reducing the distortion.

The image inclination may be corrected optically by moving the optical lens system or the imaging element, not by rotating the original image as described above.

If the attitude information processing unit 240 determines that the inclination of the high-definition video camera is smaller than the prescribed threshold value, the recording control unit 204 transfers the image data, which is free of inclination, to the storage unit 400. That is, the recording control unit 204 functions as an automatic inclination correction unit.

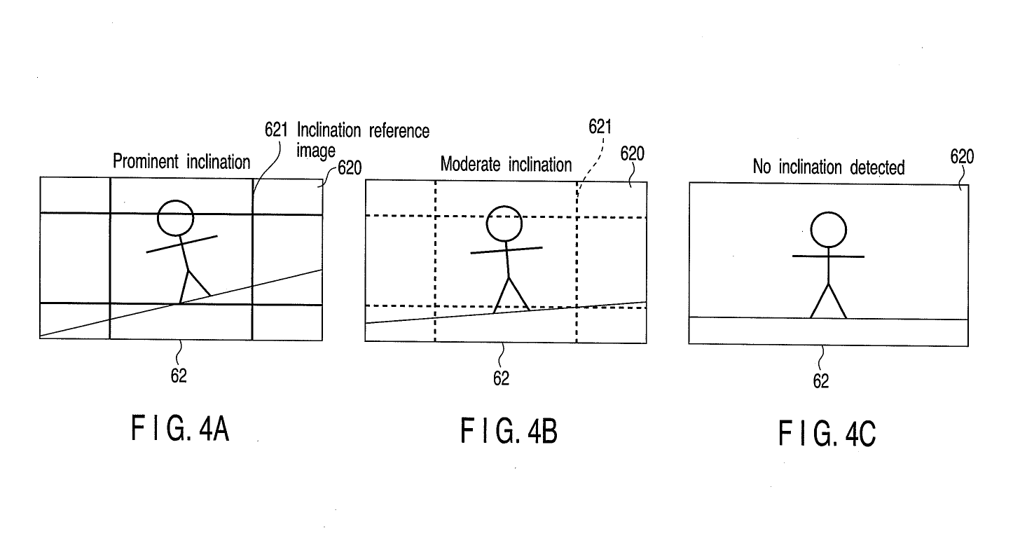

FIG. 4A, FIG. 4B, and FIG. 4C are exemplary diagrams, each showing an inclination reference image.

The images shown in FIG. 4A, FIG. 4B, and FIG. 4C are exemplary images the liquid-crystal monitor 62 may display in the photography mode. Each of these images is an image 620, which is being photographed and which will be displayed.

As FIG. 4A shows, a high-density inclination reference image 621 is displayed, overlapping the image 620 displayed, if the high-definition video camera greatly inclines. The inclination reference image 621 helps the user to visually perceive how much the image 620 displayed inclines to an inclination-free image that should be displayed if the high-definition video camera were not inclined.

The inclination reference image 621 shown in FIG. 4A consists of several lines (defining a horizontal guide frame), some extending vertically on the liquid-crystal monitor 62, and the others extending horizontally on the liquid-crystal monitor 62. The display control unit 203 causes the liquid-crystal monitor 62 to display the inclination reference image 621 in a high density if the attitude information processing unit 240 determines that the inclination of the high-definition video camera is large.

As FIG. 4B shows, an inclination reference image 621 is displayed in a low density, overlapping the image 620, if the inclination of the high-definition video camera is small. The display control unit 203 causes the liquid-crystal monitor 62 to display the inclination reference image 621 in a low density if the attitude information processing unit 240 determines that the inclination of the high-definition video camera is small.

As FIG. 4C shows, the transmittance of the inclination reference image 621 is 100% if no inclination of the high-definition video camera is detected. In other words, the liquid-crystal monitor 62 does not display the inclination reference image 621 and displays the image 620 only.

As described above, density of guide lines changes in accordance with degree of inclination.

The display control unit 203 causes the liquid-crystal monitor 62 to stop displaying the inclination reference image 621 if the attitude information processing unit 240 does not determine that the high-definition video camera is inclined or that the inclination of the camera is small enough to generate a corrected horizontal image.

As described above, the display control unit 203 determines the density (transmittance) of the inclination reference image 621 from the inclination angle of the high-definition video camera, which the attitude information processing unit 240 has calculated.

The display control unit 203 causes the liquid-crystal monitor 62 to display the inclination reference image 621 in a high density if the high-definition video camera is inclined by a large angle, and in a low density if the high-definition video camera is inclined by a small angle. Alternatively, the inclination reference image 621 may be changed in color, not in density, in accordance with the inclination angle of the high-definition video camera.

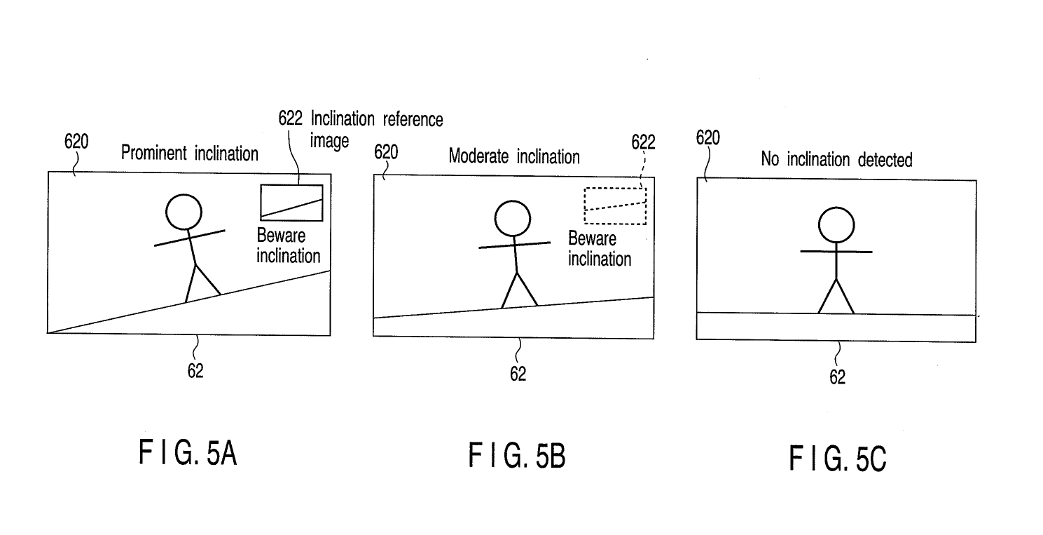

FIG. 5A, FIG. 5B, and FIG. 5C are exemplary diagrams, each showing another type of an inclination reference image.

The images shown in FIG. 5A, FIG. 5B, and FIG. 5C are exemplary images the liquid-crystal monitor 62 may display in the photography mode. Each of these images is an image 620, which is being photographed and which will be displayed.

As FIG. 5A shows, a high-density inclination reference image 622 is displayed in a high density, overlapping the image 620 displayed, if the high-definition video camera greatly inclines. The inclination reference image 622 helps the user to visually perceive how much the image 620 displayed inclines to an inclination-free image that should be displayed if the high-definition video camera were not inclined.

In this instance, the inclination reference image 622 is an inclined frame image that is defined by a frame and a straight line. The straight line indicates the degree of inclination of the high-definition video camera. The inclination reference image 622 is displayed at the upper right corner of the screen. The straight line in the frame changes in direction as the high-definition video camera inclines.

The display control unit 203 causes the liquid-crystal monitor 62 to display the inclination reference image 622 in a high density if the attitude information processing unit 240 determines that the inclination of the high-definition video camera is large.

As FIG. 5B shows, the inclination reference image 622 is displayed in a low density, overlapping the image 620, if the inclination of the high-definition video camera is small. The display control unit 203 causes the liquid-crystal monitor 62 to display the inclination reference image 622 in a low density if the attitude information processing unit 240 determines that the inclination of the high-definition video camera is small.

As FIG. 5C shows, the inclination reference image 622 is displayed in a high density, overlapping the image 620, if the inclination of the high-definition video camera is large. The display control unit 203 causes the liquid-crystal monitor 62 to stop displaying the inclination reference image 622 if the attitude information processing unit 240 does not determine that the high-definition video camera is inclined or that the inclination of the camera is small enough to generate a corrected horizontal image.

As described above, the display control unit 203 determines the density (transmittance) of the inclination reference image 622 from the inclination angle of the high-definition video camera, which the attitude information processing unit 240 has calculated.

The display control unit 203 causes the liquid-crystal monitor 62 to display the inclination reference image 622 in a high density if the high-definition video camera is inclined by a large angle, and in a low density if the high-definition video camera is inclined by a small angle. That is, the density of the inclination reference image 622 is gradually lowered as the inclination of the camera decreases.

Alternatively, the inclination reference image 621 may be changed in color, not in density, in accordance with the inclination angle of the high-definition video camera. Moreover, a maximum inclination angle may be preset, and an alarm may be generated if the high-definition video camera inclines by an angle greater than the maximum inclination angle, informing the user of this event.

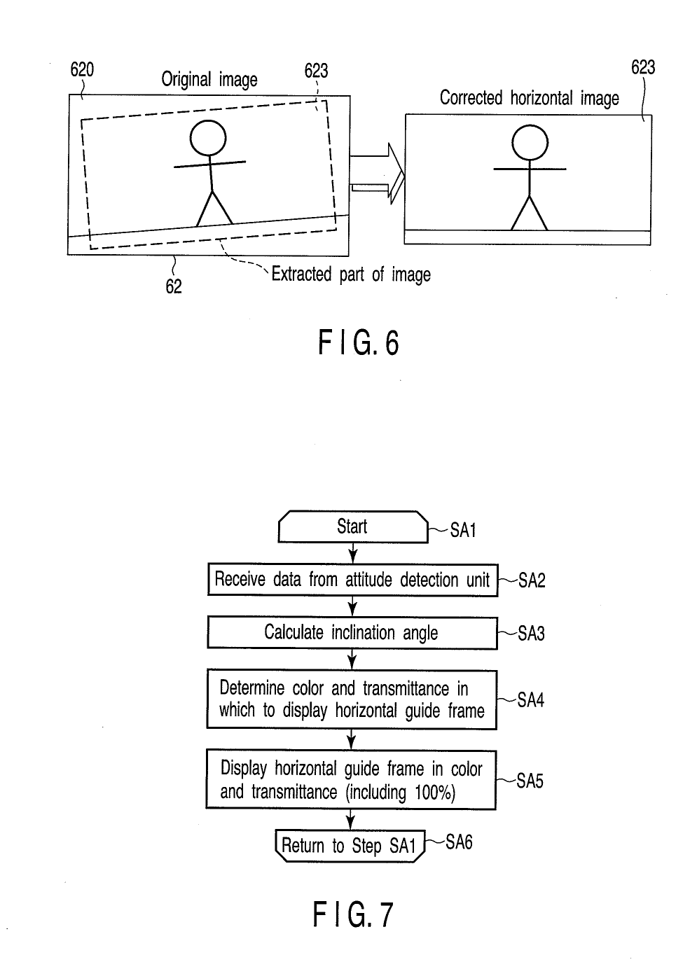

FIG. 6 is a diagram explaining how to generate a corrected horizontal image.

If the inclination of the high-definition video camera is smaller than the prescribed threshold value, a part of the original image is extracted as is illustrated in FIG. 6, thereby generating a corrected horizontal image.

More specifically, the recording control unit 204 sets an image extraction frame in the original image in order to extract a corrected image (horizontal corrected image) 623. That part of the original image, which lies within the image extraction frame, is extracted as inclination-corrected image, i.e., corrected horizontal image 623.

In this case, the recording control unit 204 cancels the inclination with respect to the longer sides of the original image and sets an image extraction frame that has an aspect ratio of 16:9.

FIG. 7 is a flowchart explaining how the system control unit 20 performs a process to display the inclination reference image 621 shown in FIG. 4.

The system control unit 20 starts performing the process (Step SA1). Then, the system control unit 20 receives an attitude signal from the attitude detection unit 23 (Step SA2). The system control unit 20 calculates the inclination angle at which the high-definition video camera inclines to the horizon, from the attitude signal acquired from the attitude detection unit 23 (Step SA3).

The system control unit 20 causes the display control unit 203 to determine the color and transmittance in which to display the inclination reference image 621, i.e., horizontal guide frame, in accordance with the inclination angle calculated in Step SA3 (Step SA4).

The system control unit 20 controls the display control unit 203, which causes the liquid-crystal monitor 62 to display the horizontal guide frame in the color and transmittance determined in Step SA4, in combination with the image represented by the image data (Step SA5). The system control unit 20 then returns to the Step SA1 and starts processing the next frame (Step SA6).

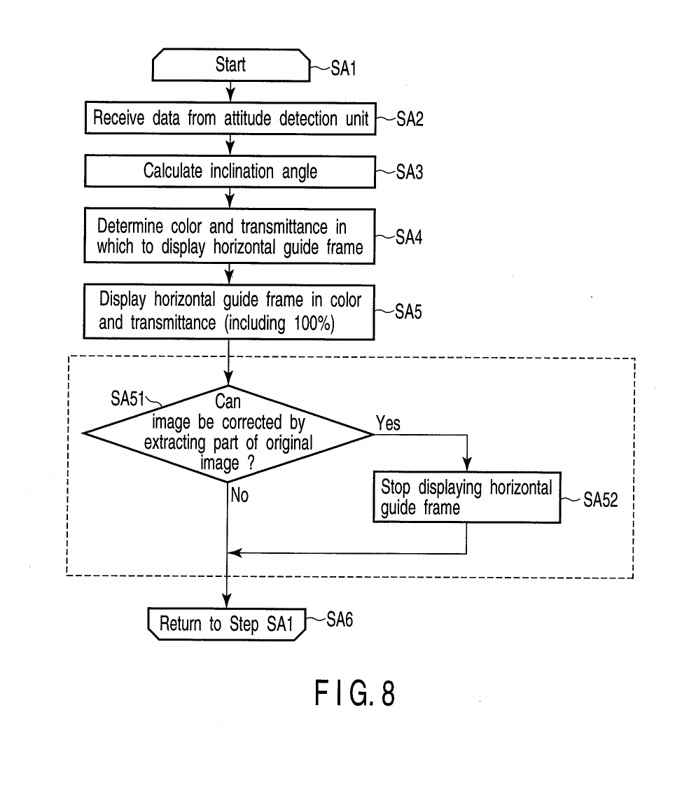

FIG. 8 is a flowchart explaining how the system control unit 20 performs the process of correcting the inclination. The steps identical to those shown in the flowchart of FIG. 7 are designated by the same reference numbers and will not be described.

As FIG. 8 shows, upon performing Step SA5, the system control unit 20 determines whether the image can be corrected by extracting a part of the original image as described above (Step SA51). More precisely, the system control unit 20 determines whether the inclination of the high-definition video camera is smaller than the prescribed threshold value.

If the inclination of the high-definition video camera found to be smaller than the prescribed threshold value, the system control unit 20 causes the display control unit 203 to change the transmittance of the horizontal guide frame to 100%. That is, the display control unit 203 makes the liquid-crystal monitor 62 stop displaying the horizontal guide frame (Step SA52).

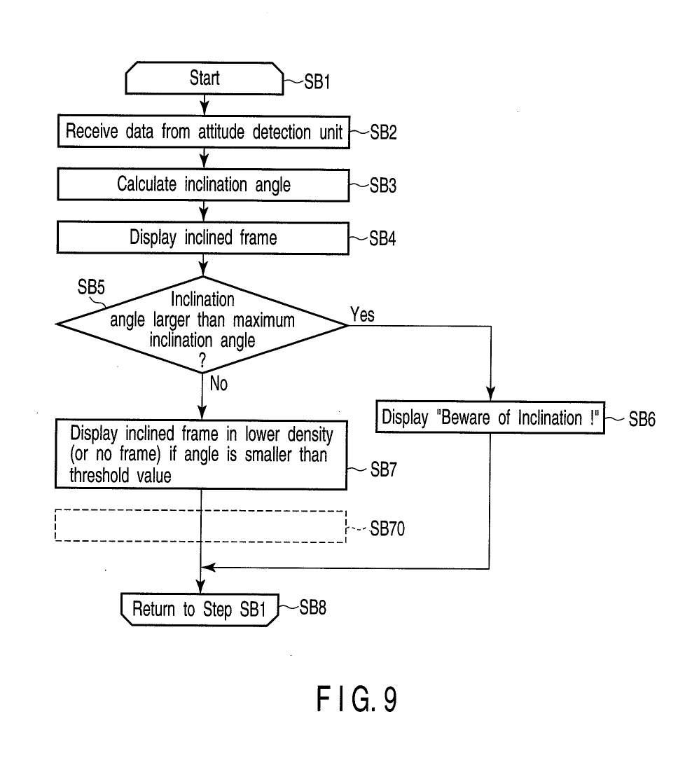

FIG. 9 is a flowchart explaining how the system control unit 20 performs a process to display an inclination reference image 622 shown in FIG. 5.

The system control unit 20 starts performing this process (Step SB1). Then, the system control unit 20 acquires an attitude signal from the attitude detection unit 23 (Step SB2). The system control unit 20 causes the attitude information processing unit 240 to calculate the angle at which the high-definition video camera inclines to the horizon, from the attitude signal acquired (Step SB3).

The system control unit 20 causes the display control unit 203 to determine the color and transmittance in which to display an inclination reference image 622, i.e., inclined frame, from the inclination angle calculated in Step SB3. Then, the system control unit 20 determines whether the inclination angle of the high-definition video camera is larger than the maximum inclination angle (Step SB5).

The inclination angle of the high-definition video camera may be larger than the maximum inclination angle (YES in Step SB5). In this case, the system control unit 20 controls the display control unit 203, which causes the liquid-crystal monitor 62 to display an alarm to the user (Step SB6).

On the other hand, the inclination angle of the high-definition video camera may be smaller or more equal than the maximum inclination angle (NO in Step SB5). In this case, the system control unit 20 controls the display control unit 203, which causes the liquid-crystal monitor 62 to display the inclined frame in a lower density (Step SB7).

Further, the system control unit 20 performs the same process as Steps SA51 and SA52 shown in FIG. 8 (Step SB70). That is, the system control unit 20 determines whether the image can be corrected by extracting a part of the original image as described above, and the display control unit 203 makes the liquid-crystal monitor 62 stop displaying the horizontal guide frame if the image can be so corrected.

Upon processing one frame, the system control unit 20 starts processing the next frame. More specifically, the system control unit 20 returns to Step SB1 (Step SB8).

As described above, in the present embodiment, the inclination reference image is displayed in a high density if the inclination is large, and in a low density if the inclination is small. Thus, the inclination reference image is not conspicuous if the high-definition video camera is inclined but a little. The inclination reference image does not bother the user who is taking pictures.

Hence, the user can concentrate the user mind on taking a moving picture or still pictures. If the inclination correction function works while the high-definition video camera remains in the photography mode, the user need not correct the inclination of the camera by all means. Therefore, the high-definition video camera is easy for the user to use and handle.

The present invention is not limited to the embodiments described above. The components of any embodiment can be modified in various manners in reducing the invention to practice, without departing from the spirit or scope of the invention. Further, the components of any embodiment described above may be combined, if necessary, in various ways to make different inventions. For example, some of the component of any embodiment may not be used. Moreover, the components of the different embodiments may be combined in any desired fashion.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A photographic apparatus comprising:
an image capturing module configured to capture image data;
an image data processing module configured to process the image data captured by the image capturing module;
a display to display an image after processed in the image data processing module;
a rotation detection module configured to detect an amount of rotation of a main body of the photographic apparatus and to output rotation information; and
a controller configured to control the image capturing module, the image data processing module and the display,
wherein the controller comprises:
a reference image output module configured to output to the display a rotation reference image allowing a user to visually perceive the degree of rotation of a main body; and
a gradation control module configured to control gradation of the rotation reference image, by changing the gradation of the rotation reference image in accordance with the degree of the rotation of the main body.

2. The photographic apparatus of claim 1, wherein the rotation reference image comprises lines, some extending vertically on the display, and the others extending horizontally on the display.

3. The photographic apparatus of claim 1, wherein the rotation reference image comprises lines extending horizontally at one corner of the display.

4. The photographic apparatus of claim 1, wherein the gradation control module is configured to cause the display to stop displaying the lines when the rotation of the main body becomes smaller than or equal to a predetermined threshold value.

5. The photographic apparatus of claim 1, further comprising:
a first storage device configured to store the image data processed by the image data processing module,
wherein the image data processing module further comprises a second storage device; and
the controller comprises an automatic rotation correction module configured to control a region of the second storage device to be read out in order to transfer the image data to the first storage device without an effect of the rotation the main body, when the rotation is smaller than a predetermined threshold value.

6. A method of controlling a photographic apparatus comprising:
capturing image data;
processing the image data captured in the step of image capturing;
displaying an image after the step of processing;
detecting rotation of a main body of the photographic apparatus;
outputting rotation information; and
controlling the steps of image capturing, the image data processing, and the displaying, wherein the method further comprises:
outputting to the display a rotation reference image allowing a user to visually perceive the degree of rotation of a main body; and
controlling gradation of the rotation reference image in accordance with the rotation information.

7. The method of claim 6, wherein the rotation reference image displayed comprises lines, some extending vertically on the display, and the others extending horizontally on the display.

8. The method of claim 6, wherein the rotation reference image displayed comprises lines extending horizontally at one corner of the display.

9. The method of claim 6, wherein the gradation control module is configured to cause the display to stop displaying the lines when the rotation of the main body becomes smaller than a predetermined threshold value.
